(19) United States
(12) Patent Application Publication
(10) Pub. No.: US 2008/0136246 A1
(43) Pub. Date: Jun. 12, 2008

(54) Safety Ski Harness for Children

(76) Inventor: Robert Salter, Toronto (CA)

Correspondence Address: SHOEMAKER AND MATTARE, LTD, 10 POST OFFICE ROAD - SUITE 110, SILVER SPRING, MD, 20910, US

(21) Appl. No.: 11/609,470

(22) Filed: Dec. 12, 2006

(51) Int. Cl. B60R 21/00

(52) U.S. Cl. 297/485

(57) ABSTRACT

A safety harness is provided for use on ski/chair-lifts for restraining a smaller rider. The safety harness comprises a body section having a rear panel, first and second girth panels, and first and second shoulder panels, the panels being configured generally in the form of a vest. The safety harness further comprises at least one strap for positioning and tightening the body section on the smaller rider. The rear panel is provided with a retaining loop, the retaining loop being sized to permit an adjacently positioned adult rider to place an arm therethrough, so as to restrain the smaller rider.

### FIELD OF THE INVENTION

The present invention relates to a safety harness to be used by smaller riders (e.g. children) while ascending a ski slope on a ski/chair-lift or the like.

### BACKGROUND OF THE INVENTION

Winter months have long posed a particular challenge when it comes to maintaining a healthy level of physical activity. While indoor organized sport has seen a steady growth over the years, outdoor sport such as skiing has seen tremendous growth. With the development of ski equipment and facilities suited for younger participants, families are increasingly heading to the slopes for what is a truly family oriented sport.

Unfortunately, child safety features on ski lifts (such as chair lifts) remain largely unaddressed. One reason for the paucity in such child safety features is that alterations to the ski lift infrastructure are subject to exorbitant costs, as well as the requirement for detailed studies on the safety of design modifications. Many parents ultimately find themselves attempting to restrain the child in some manner so as to keep them safe during their ascent. This is particularly difficult considering the sometimes cumbersome nature of the clothing being worn, as well as the accompanying ski equipment.

In the absence of substantial design modifications to current ski/chair-lifts, there clearly exists a need for a device that allows an adult to secure a child during the ascent without being obstructive or unsafe during the subsequent skiing session.

### SUMMARY OF THE INVENTION

According to an aspect of the present invention, a safety harness is provided for use on ski/chair-lifts for restraining a smaller rider, the safety harness comprising:

a body section having a rear panel, first and second girth panels, and first and second shoulder panels, the panels being configured generally in the form of a vest;

at least one strap for positioning and tightening said body section on the smaller rider;

a retaining loop on the rear panel, said retaining loop being sized to permit an adjacently positioned adult rider to place an arm therethrough, so as to restrain the smaller rider.

This together with other aspects and advantages that will be subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a front perspective view of the safety harness shown being worn by a small child;

FIG. 2a is a front perspective view of the safety harness of FIG. 1, removed from the wearer;

FIG. 2b is a rear perspective view of the safety harness of FIG. 1, removed from the wearer, and wherein the retaining loop is shown in the retracted position;

FIG. 2c is a rear perspective view of the safety harness of FIG. 1, removed from the wearer, and wherein the retaining loop is shown in the extended position;

FIG. 3 is a rear perspective view of the safety harness of FIG. 1 in use on a ski/chair-lift transporting and adult and child, wherein the adult uses the opposing sidebar as an anchor point; and

FIG. 4 is a front perspective view detailing placement of the adults arm relative to the safety harness of FIG. 1; wherein the adult is using an anchor loop on the safety harness.

### DESCRIPTION OF THE EMBODIMENTS

Many of the ski/chair-lifts currently in use are designed for adult-sized occupants, resulting in an anthropometric mismatch between the restraint mechanism and smaller riders, particularly children. While enclosed capsule or gondola-style lifts are increasingly being installed, the vast majority of traditional ski/chair-lifts generally comprise a chair section for supporting two (or more) skiers, and a safety or lap bar that pivots into position just above the waist/lap line of the occupant. Unlike similar configurations found on, for example amusement rides, ski/chair-lifts generally do not comprise restraint mechanisms having crotch straps or similar means preventing a child from slipping below the safety bar.

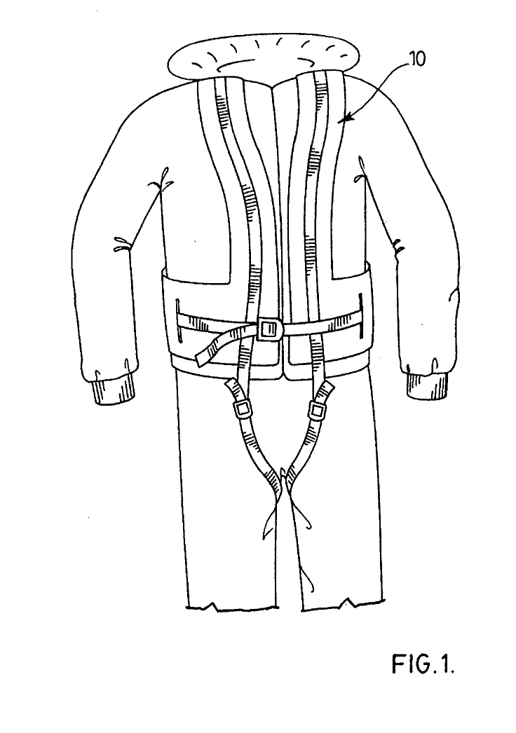

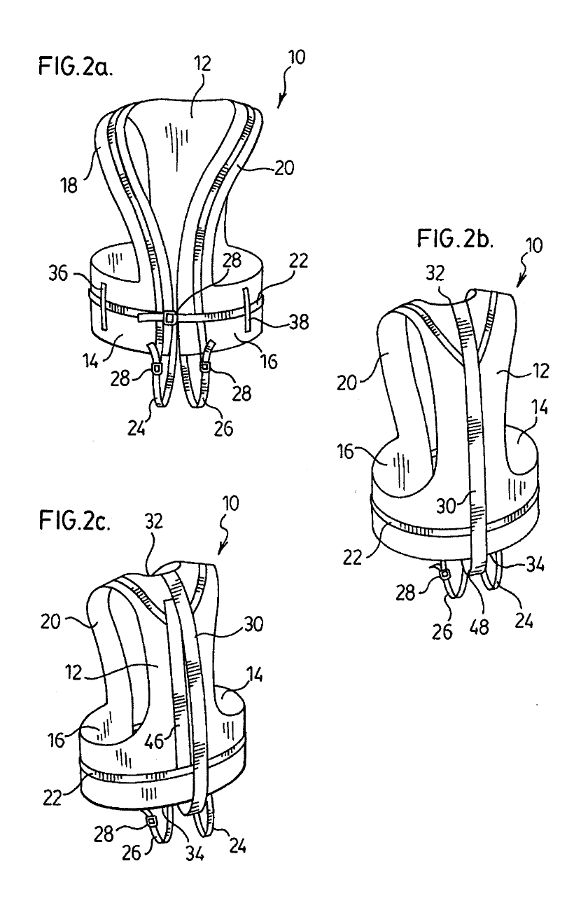

Turning now to FIG. 1, a safety harness is shown in accordance with an aspect of the invention, in position on a wearer (i.e. a child), the safety harness being generally indicated by the numeral 10. For clarity, the safety harness 10 is also shown in FIGS. 2a through 2c, removed from the wearer. The safety harness 10 comprises a body section having a rear panel 12, opposing girth panels 14, 16 and respective shoulder/chest panels 18, 20. The safety harness 10 is configured to be worn over conventional ski attire, and generally takes the form of a vest. The safety harness 10 is retained in position on the wearer by way of nylon straps. As shown, the safety harness is provided with a girth strap 22 spanning the girth panels, as well as two crotch straps 24, 26. Cooperating nylon straps are locked together using adjustable buckles 28, allowing the safety harness to be tightened and well fitted to the specific wearer.

As shown in FIGS. 2b and 2c, the safety harness is also provided with a retaining loop 30 on the rear panel 12 of the body section. As shown, the retaining loop extends from the collar rim 32 down to the lower edging 34. In addition, an anchor loop 36, 38 is provided on each respective girth panel 14, 16.

For comfort, each of the panels is provided with suitable padding. In addition, the panels are sized so as to reduce the likelihood of pressure points upon the wearer. For example, in a preferred embodiment, the shoulder panels are approximately 2 inches wide, padded for added comfort, and trimmed with polar fleece or similar material.

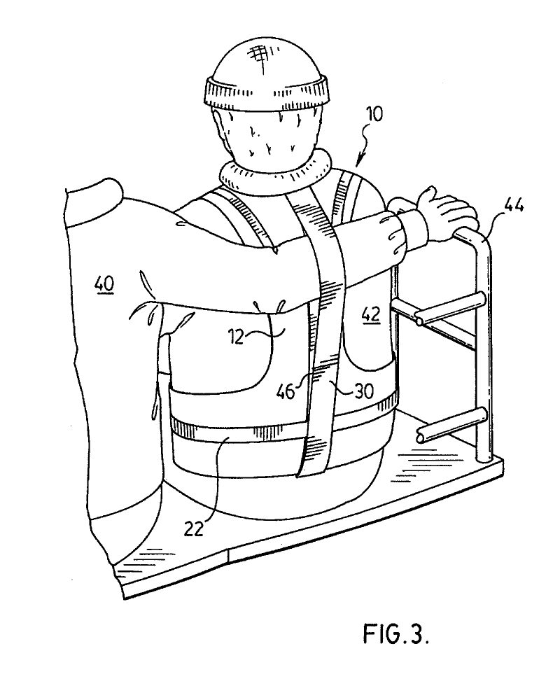

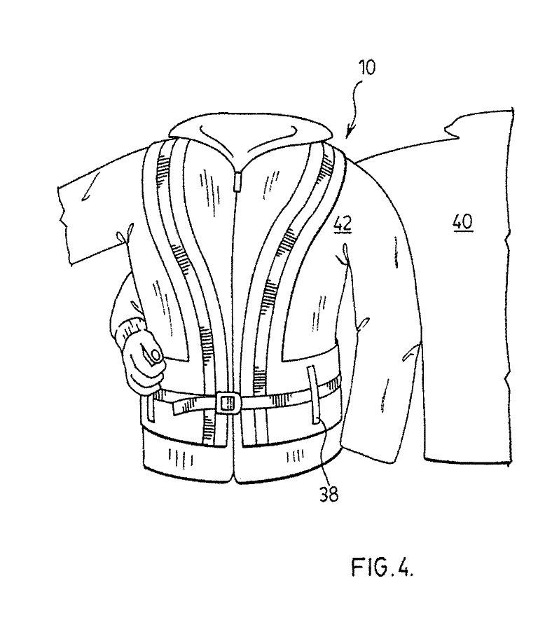

In use, the safety harness allows an adult to temporarily restrain the smaller rider while ascending a ski hill on a ski/chair-lift. This usage is best shown in FIG. 3 in which a two-person ski/chair-lift is occupied by an adult 40 and a child 42. The mechanics and structure of the ski/chair-lift are largely omitted so as to refrain from obstructing the view of the safety harness. One skilled in the art will appreciate the safety harness is applicable to a wide variety of ski/chair-lift configurations. As shown, the adult 40 is able to pass an arm from the side, through the restraining loop 30 to prevent the child 42 from falling or slipping forward. The adult may grasp the ski/chair-lift (i.e. an arm rest 44 or opposing side bar) on the far side as shown in FIG. 3, or optionally may grasp the anchor loop 36 on the girth panel 14, as shown in FIG. 4. The adult may also rest their hand in the vicinity of the child's hip, and when necessary, the adult may rotate their hand/arm so as to press against the rear of the seat, effectively restraining the child from moving in the forward direction. The safety harness 10 is usable from both sides, as an anchor loop 36, 38 is provided on each respective girth panel 14, 16. This not only allows for preference to left or right-handed use, but also ensures that regardless of which side the child ends up on relative to the adult, the adult is able to securely restrain the child in position during the ascent. To reduce the likelihood of the anchor loops snagging on objects during the descent, the anchor loops are configured to retract into a flattened position. To accomplish this, the anchor loops are generally made of a suitable elasticized rope/cord or similar material, that has a bias towards the flattened position.

FIGS. 2b and 2c show in greater detail the retaining loop 30 and its functionality on the rear panel 12. During a ski session, the retaining loop 30 is in the retracted/flattened position shown in FIG. 2b, so as to reduce the likelihood of hang-ups during the skier's descent. The retaining loop 30 is maintained in this configuration by way of hook-and-loop fasteners 46 situated between the inside surface of the retaining loop 30 and the rear panel 12. When required, the retaining loop 30 may be freed from the rear panel, opening a space that allows for placement of an adult's arm therethrough, as shown in FIG. 2c. The necessary spacing in the retaining loop 30 to allow an adult's arm to pass therethrough is provided by a folded overhang 48 at the lower portion of the retaining loop 30, adjacent the lower edging 34. To assist with the opening of the retaining loop 30, a portion of the retaining loop/rear panel (i.e. in the vicinity of the overhang 48) is configured without the hook-and-loop fastener, thereby providing a ‘start’ point for freeing the retaining loop 30.

Although embodiments of the invention have been described and illustrated in detail, various modifications and changes may be made. While preferred embodiments are described above, some of the features described above can be replaced or even omitted. For example, instead of the safety harness being provided in a vest configuration, the harness may be incorporated into a ski jacket or coat along with the necessary strapping to retain the device in position. While nylon is a preferred construction material, particularly for the strapping, other suitable materials having similar strength characteristics may be used. Although a hook-and-loop fastener is used to maintain the restraining loop in a flattened position, it is also possible to use a ‘stretch’ material for the retaining loop. The stretch material would allow an adult to place their arm through the device, and would subsequently retract when not in use. Alternatively, the restraining loop could be configured as a sleeve in a generally horizontal position. In the embodiment shown above, the safety harness is provided with a single girth strap, and two crotch straps. The safety harness may alternatively be provided with fewer, or more straps as required to ensure the device does not separate from the wearer. Still further alternatives and modifications may occur to those skilled in the art. All such alternatives and modifications are believed to be within the scope of the invention.

1. A safety harness for use on ski/chair-lifts for restraining a smaller rider, the safety harness comprising:
a body section having a rear panel, first and second girth panels, and first and second shoulder panels, the panels being configured generally in the form of a vest;
at least one strap for positioning and tightening said body section on the smaller rider;
a retaining loop on the rear panel, said retaining loop being sized to permit an adjacently positioned adult rider to place an arm therethrough, so as to restrain the smaller rider.

2. The safety harness according to claim 1, wherein the body section comprises a girth strap spanning said first and second girth panels.

3. The safety harness according to claim 2, further comprising at least one crotch strap spanning from said rear panel to one of said first and second girth panels.

4. The safety harness according to claim 2, further comprising two crotch straps, each of said two crotch straps spanning from said rear panel to a respective one of said first and second girth panels.

5. The safety harness according to claim 4, wherein each of said crotch straps and said girth strap are provided with an adjustable buckle for adjusting the fit of the body section to suit the specific wearer.

6. The safety harness according to claim 1, wherein said retaining loop generally extends the entire length of the rear panel, from collar rim to lower edging.

7. The safety harness according to claim 1, wherein the retaining loop is configured with a folded overhang to provide a spacing that permits an adult's arm to pass therethrough.

8. The safety harness according to claim 1, wherein each of said first and second girth panels are provided with at least one anchor loop.

9. The safety harness according to claim 8, wherein said at least one anchor loop is comprised of an elasticized rope/cord biased towards a flattened position.

10. The safety harness according to claim 1, wherein said retaining loop is maintained in a retracted position by a of hook-and-loop fastener situated between an inside surface of said retaining loop and said rear panel.
